(19) United States
(12) Patent Application Publication
(10) Pub. No.: US 2022/0042487 A1
(43) Pub. Date: Feb. 10, 2022

(54) ADAPTIVE-ADJUSTMENT METHOD, ELECTRONIC DEVICE AND STORAGE MEDIUM FOR ENGINE OPERATION

(71) Applicant: Qi'an CHEN, Rui'an (CN)

(72) Inventors: Qi'an CHEN, Rui'an (CN); Beiwu JIN, Rui'an (CN)

(21) Appl. No.: 17/216,683

(22) Filed: Mar. 30, 2021

(30) Foreign Application Priority Data
Aug. 6, 2020 (CN) 202010784108.X

(51) Int. Cl. F02P 5/04; F02D 41/30; F02P 5/15

(52) U.S. Cl. CPC F02P 5/045; F02D 41/30; F02D 2200/021; F02D 2200/101; F02P 5/1502

(57) ABSTRACT

An adaptive-adjustment method for engine operation includes: upon receipt of an instruction, reducing a ratio of air to fuel of an engine until a rotational speed after the reduction is less than the rotation speed before the reduction, and a rotational speed difference between the rotational speeds before and after the reduction is greater than a preset drop value; increasing the ratio of air to fuel of the engine until the rotational speed after the increase is less than the rotational speed before the increase, and a rotational speed difference between the rotational speeds before and after the increase is greater than the preset drop value; determining an offset of a control parameter corresponding to an adaptive-adjustment state for the engine according to a reduced ratio of air to fuel and an increased ratio of air to fuel; and controlling the engine at a current time according to the offset.

### CROSS-REFERENCE TO RELATED APPLICATIONS

This application claims all benefits accruing under 35 U.S.C. § 119 from China Patent Application No. 202010784108.X, filed on Aug. 6, 2020, in the China National Intellectual Property Administration, the content of which is hereby incorporated by reference.

### TECHNICAL FIELD

The present disclosure generally relates to the technical field of engine fuel control, and in particular, to an adaptive-adjustment method, an electronic device and a storage medium for the operation of a low-cost and light-load internal combustion engine.

### BACKGROUND

An engine is a machine capable of converting other forms of energy into mechanical energy, including, for example, an internal combustion engine, an external combustion engine (Stirling engine, steam engine, etc.), a jet engine, an electric motor, etc. The engine serves as a power source for mobile devices such as automobiles, locomotives, steamships, agricultural machines (agricultural vehicles), construction machines, and military vehicles, and the engine is an indispensable core member of the mobile device, which is mainly used for consuming petroleum.

Both an engine ignition system and a fuel injection system are important components of the engine. The engine ignition system is generally composed of a battery, a generator, an electric splitter, an ignition coil and a spark plug. When the engine is in operation, an ignition moment has a great influence on the operation performance of the engine. Previous ignition is a spark plug ignition before a piston reaches a compression upper stop point, igniting combustible mixed gas in a combustion chamber. Reaching the compression upper stop point from the ignition moment, the angle at which the crankshaft rotates within this period of time is referred to as an ignition advance angle. The ignition advance angle setting plays a decisive role in the power, economy and emissions of the engine. The fuel injection system is configured to precisely control an injection, an injection time, and an injection pressure of engine fuel, so that the fuel amount injected into a cylinder reaches an optimal value.

Existing engine ignition control and fuel injection system generally uses operating condition control to control the ignition advance angle and fuel injection of the engine. The current fuel injection system of the engine generally determines the operating condition according to engine operating speed, temperature and throttle load, and then calibrates the ignition and injection of a matching EFI (electronic fuel injection) system according to the engine performance level, operating conditions and combustion conditions of the operating condition.

When the engine is operating, the operating conditions handled are often a combination of multiple operating conditions. At present, no effective solution has been proposed for a problem that the engine cannot be adaptively adjusted when composite conditions exist in the related art.

### SUMMARY

Thus, to solve the above problem in the related art at least, it is desired to provide an adaptive-adjustment method, an electronic device and a storage medium for engine operation.

According to one aspect, the present disclosure provides an adaptive-adjustment method for engine operation. The adaptive-adjustment method includes the following steps:

Upon receipt of an adaptive-adjustment instruction, reducing a ratio of air to fuel of an engine by a first preset step until a rotational speed after the reduction is less than the rotational speed before the reduction, and a rotational speed difference between the rotational speed before the reduction and the rotational speed after the reduction is greater than a preset drop value;

Increasing the ratio of air to fuel of the engine by a second preset step until the rotational speed after the increase is less than the rotational speed before the increase, and a rotational speed difference between the rotational speed before the increase and the rotational speed after the increase is greater than the preset drop value;

Determining a first offset of a control parameter corresponding to an adaptive-adjustment state for the engine according to a reduced ratio of air to fuel and an increased ratio of air to fuel, wherein the control parameter includes at least one of an ignition angle parameter and a fuel injection parameter;

Controlling operation of the engine at a current time according to at least the first offset.

In one embodiment of the present disclosure, the adaptive-adjustment method further includes:

Obtaining a reference value and a second offset of the control parameter of the engine;

The second offset includes at least one of an offset of the control parameter of the engine in a start-up state and an offset of the control parameter of the engine in a cold engine state;

The controlling the operation of the engine at the current time according to at least the first offset may include: combining the reference value, the first offset and the second offset into a final value of the control parameter, and controlling the operation of the engine at the current time according to the final value of the control parameter.

In one embodiment of the present disclosure, the obtaining the reference value of the control parameter of the engine may include:

Obtaining a rotational speed and a temperature of the engine at the current time;

Obtaining a first table of preset control parameters, including correspondence information among the rotational speed of the engine, the temperature of the engine, and the reference value of the control parameter of the engine;

Looking up a reference value of the control parameter under the rotational speed and the temperature at the current time in the first table.

In one embodiment of the present disclosure, the obtaining the second offset of the control parameter of the engine may include:

Obtaining a rotational speed and a temperature of the engine at the current time;

Detecting whether the engine is in a start-up state at the current time;

When it is detected that the engine is in a start-up state at the current time, looking up an offset of the control parameter corresponding to the start-up state under the rotational speed and the temperature in a second table of preset control parameters, and taking the offset of the control parameter corresponding to the start-up state as the second offset, wherein the second table includes correspondence information among the rotational speed of the engine, the temperature of the engine, and the offset of the control parameter of the engine in the start-up state.

In one embodiment of the present disclosure, the step of detecting whether the engine is in a start-up state at the current time may include:

Detecting a first number of revolutions from a start of the engine to the current time;

Judging whether the first number of revolutions is less than a first preset number of revolutions, wherein the first preset number of revolutions represents the number of revolutions required for the engine from the start of the engine to an exit from the start-up state;

When the first number of revolutions is less than the first preset number of revolutions, determining that the engine is in the start-up state at the current time.

In one embodiment of the present disclosure, the obtaining the second offset of the control parameter of the engine may include:

Obtaining a rotational speed and a temperature of the engine at the current time;

Detecting whether the engine is in a cold engine state at the current time;

When it is detected that the engine is in a cold engine state at the current time, looking up an offset of the control parameter corresponding to the cold engine state under the rotational speed and the temperature in a third table of preset control parameter, and taking the offset of the control parameter corresponding to the cold engine state as the second offset, wherein the third table of preset control parameter includes corresponding information among the rotational speed of the engine, the temperature of the engine, and the offset of the control parameter of the engine in the cold engine state.

In one embodiment of the present disclosure, the detecting whether the engine is in a cold engine state at the current time may include:

Determining a second preset number of revolutions corresponding to the temperature, wherein the second preset number of revolutions represents the number of revolutions required for the engine at the temperature from the start of the engine to the exit from the cold engine state;

Detecting a first number of revolutions from the start of the engine to the current time;

When the first number of revolutions is less than the second preset number of revolutions, determining that the engine is in the cold engine state at the current time.

In one embodiment of the present disclosure, the preset drop value ranges from 0-200 revolutions per minute.

According to one aspect, the present disclosure provides an adaptive-adjustment device for engine operation. The adaptive-adjustment device includes:

A reducing adjustment module, configured to reduce a ratio of air to fuel of an engine by a first preset step upon receipt of an adaptive-adjustment instruction, until a rotational speed after the reduction is less than the rotational speed before the reduction, and a rotational speed difference between the rotational speed before the reduction and the rotational speed after the reduction is greater than a preset drop value;

An increasing adjustment module, configured to increase the ratio of air to fuel of the engine by a second preset step until the rotational speed after the increase is less than the rotational speed before the increase, and a rotational speed difference between the rotational speed before the increase and the rotational speed after the increase is greater than the preset drop value;

A processing module, configured to determine a first offset of a control parameter corresponding to an adaptive-adjustment state for the engine according to a reduced ratio of air to fuel and an increased ratio of air to fuel;

A control module, configured to control operation of the engine at a current time according to at least the first offset.

According to one aspect, the present disclosure provides an electronic device, including a memory, a processor and a computer program stored on the memory and executed on the processor. The processor can execute the computer program to implement the adaptive-adjustment method for engine operation as described in the one aspect above.

According to another aspect, the present disclosure provides a storage medium on which a computer program is stored, wherein the computer program is executed by a processor to implement an adaptive-adjustment method for engine operation as described in the one aspect above.

Compared with the related art, the method for adaptively adjusting engine operation, the electronic device and the storage medium are provided by the present disclosure. Upon receipt of an adaptive-adjustment instruction, reducing a ratio of air to fuel of an engine by a first preset step until a rotational speed after the reduction is less than the rotational speed before the reduction, and a rotational speed difference between the rotational speed before the reduction and the rotational speed after the reduction is greater than a preset drop value; increasing the ratio of air to fuel of the engine by a second preset step until the rotational speed after the increase is less than the rotational speed before the increase, and a rotational speed difference between the rotational speed before the increase and the rotational speed after the increase is greater than the preset drop value; determining a first offset of a control parameter corresponding to an adaptive-adjustment state for the engine according to a reduced ratio of air to fuel and an increased ratio of air to fuel, wherein the control parameter includes at least one of an ignition angle parameter and an fuel injection parameter; controlling the engine at a current time according to at least the first offset. By means of the present disclosure, the problem in the related art that the engine cannot be adaptively adjusted when the composite conditions exist is solved, thereby achieving optimal control and saving operation time in the composite conditions of the engine.

Details of one or more embodiments of the present disclosure are set forth in the following figures and description to make other features, objects and advantages of the present disclosure more concise.

### BRIEF DESCRIPTION OF THE DRAWINGS

The drawings illustrated herein are used to provide a further understanding of the present disclosure and form a part of the present disclosure, and the schematic embodiments of the present disclosure and the description thereof are used to explain the present disclosure and do not constitute an undue limitation of the present disclosure. In the drawings:

FIG. 1 is a block diagram of a hardware structure of a terminal for an adaptive-adjustment method for engine operation according to an embodiment of the present disclosure.

FIG. 2 is a flowchart diagram of an adaptive-adjustment method for engine operation according to an embodiment of the present disclosure.

FIG. 3 is a flowchart diagram of operation control of an engine in an adaptive-adjustment state according to an embodiment of the present disclosure.

FIG. 4 is a flowchart diagram of operation control of an engine in a start-up state according to an embodiment of the present disclosure.

FIG. 5 is a flowchart diagram of operation control of an engine in a cold engine state according to an embodiment of the present disclosure.

FIG. 6 is a flowchart diagram of an adaptive-adjustment method for engine operation according to an embodiment of the present disclosure.

FIG. 7 is a block diagram of a structure of an adaptive-adjustment device for engine operation according to an embodiment of the present disclosure.

### DETAILED DESCRIPTION OF THE EMBODIMENT

The present disclosure will be further described in detail below with reference to the drawings and specific embodiments, in order to better understand the objective, the technical solution and the advantage of the present disclosure. It should be understood that the specific embodiments described herein are merely illustrative and are not intended to limit the scope of the present disclosure. Based on the embodiments of the present disclosure, all other embodiments obtained by a person of ordinary skill in the art without creative efforts all belong to the scope of protection of the present disclosure.

It is apparent that the drawings in the following description are only some examples or embodiments of the present disclosure, and the present disclosure can be applied to other similar scenarios based on these drawings without creative effort to the person of ordinary skill in the art. It is also understood that, although the efforts made in such development process may be complex and lengthy, some changes like design, manufacturing or production based on the technical content disclosed in the present disclosure are only conventional technical means for the person of ordinary skill in the art related to the content disclosed in the present disclosure, and should not be construed as inadequate for the content disclosed in the present disclosure.

References to “embodiment” in the present disclosure mean that particular features, structures, or characteristics described in connection with an embodiment may be included in at least one embodiment of the present disclosure. The occurrence of the phrase at various points in the specification does not necessarily mean the same embodiment, nor is it a separate or alternative embodiment that is mutually exclusive with other embodiments. It is understood, both explicitly and implicitly, by the person of ordinary skill in the art that the embodiments described in the present disclosure may be combined with other embodiments without conflict.

Unless otherwise defined, the technical terms or scientific terms involved in the present disclosure shall have the ordinary meaning as understood by the person of ordinary skill in the art to which the present disclosure belongs. The terms “one”, “a”, “an”, “the” and similar terms used in the present disclosure do not indicate a quantitative limitation, and can mean/connote/include singular or plural. The terms “include”, “comprise”, “have” and any variation thereof, as used in the present disclosure, are intended to cover non-exclusive encompassment. For example, a process, a method, a system, a product, or a device that includes a series of steps or modules (units) is not limited to the listed steps or modules (units), but may also include steps or modules (units) that are not listed, or may also include other steps or modules (units) that are inherent to the process, the method, the product or the device. The terms “connection”, “connected”, “coupled” and similar terms used in the present disclosure are not limited to physical or mechanical connections, but may include electrical connections directly or indirectly. The term “plurality” as used in the present disclosure refers to two or more. The word “at least one of” describes the relationship of the associated objects and indicates that three relationships can exist, for example, “at least one of A and B” can indicate the presence of A alone, A and B together, and B alone. The terms “first”, “second”, “third”, etc. in the present disclosure are only to distinguish similar objects, and do not represent a specific ordering of objects.

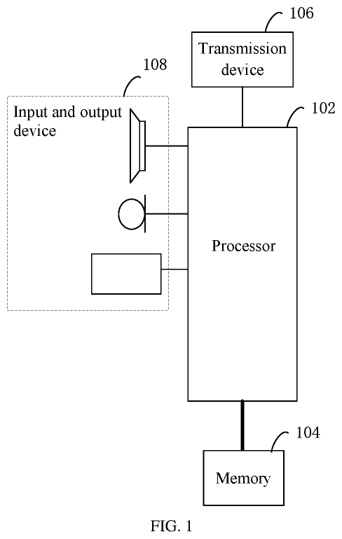

According to an embodiment, a method provided in the present disclosure can be executed in a terminal, a computer, or similar computing devices. As an example of executing in a terminal, FIG. 1 is a block diagram of a hardware structure of a terminal for an adaptive-adjustment method for engine operation according to an embodiment of the present disclosure. As shown in FIG. 1, the terminal may include one or more (only one is shown in FIG. 1) processors 102 and a memory 104 for storing data. The processors 102 may include, but are not limited to, processing devices such as MCUs or FPGAs. Optionally, the terminal may also include transmission devices 106, and input and output devices 108 for communication. A person of ordinary skill in the art can understand that a structure shown in FIG. 1 is only for illustration, and not intended to limit the structure of the above terminal. For example, the terminal may also include more or fewer components than that shown in FIG. 1, or may have a different configuration from that shown in FIG. 1.

The memory 104 may be used to store computer programs, for example, software programs and modules for application software, such as the computer program corresponding to the adaptive-adjustment method for engine operation in embodiments of the present disclosure. The processor 102 performs various functional applications as well as data processing by executing the computer programs stored in the memory 104, so as to implement the method described above. The memory 104 may include a high-speed random memory and may also include a non-transitory memory, such as one or more magnetic storage devices, flash memories, or other non-transitory solid state memories. In some embodiments, the memory 104 may further include a memory that is remotely located relative to the processor 102, and the remote memory may be connected to the terminal via networks. The networks may include, but are not limited to, the internet, an intranet, a local area network, a mobile communication network, and combination thereof.

The transmission device 106 is used to receive or send data via a network. Specifically, the network described here may include a wireless network provided by communication provider for the terminal. In an embodiment, the transmission device 106 may include a Network Interface Controller (NIC) that can be connected to other network devices via a base station so that it can communicate with the internet. In an embodiment, the transmission device 106 may be a Radio Frequency (RF) module that is used to communicate with the internet wirelessly.

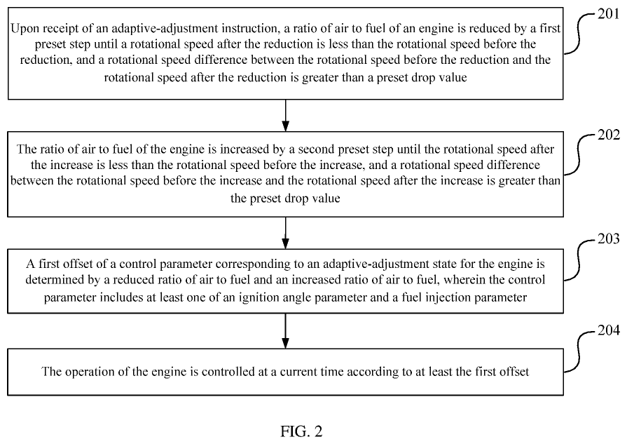

This embodiment provides an adaptive-adjustment method for engine operation. FIG. 2 is a flowchart diagram of an adaptive-adjustment method for engine operation according to the embodiment of the present disclosure. As shown in FIG. 2, the flowchart may include the following steps:

At step 201, upon receipt of an adaptive-adjustment instruction, a ratio of air to fuel of an engine is reduced by a first preset step until a rotational speed after the reduction is less than the rotational speed before the reduction, and a rotational speed difference between the rotational speed before the reduction and the rotational speed after the reduction is greater than a preset drop value.

At step 202, the ratio of air to fuel of the engine is increased by a second preset step until the rotational speed after the increase is less than the rotational speed before the increase, and a rotational speed difference between the rotational speed before the increase and the rotational speed after the increase is greater than the preset drop value.

In this embodiment, when the adaptive-adjustment instruction is received, it means that the engine is judged to be in need of adaptive-adjustment. At this time, the engine is controlled to carry out the adaptive-adjustment, and when the engine carries out the adaptive-adjustment, the first step is to reduce the ratio of air to fuel. After the desired effect of the engine's operating state can be achieved by reducing the ratio of air to fuel, the ratio of air to fuel is increased until the desired effect of the engine's operating state can also be achieved, so that the first offset corresponding to the adaptive-adjustment state of the engine may be determined.

At step 203, a first offset of a control parameter corresponding to an adaptive-adjustment state for the engine is determined by a reduced ratio of air to fuel and an increased ratio of air to fuel, wherein the control parameter includes at least one of an ignition angle parameter and a fuel injection parameter.

In this embodiment, an ignition time (ignition angle) and a ratio of air to fuel (injection) of combustible mixture desired by the adaptive-adjustment state are determined by the first offset. In this embodiment, the adaptive-adjustment is used to obtain an optimal fuel consumption point of the engine.

At step 204, the operation of the engine is controlled at a current time according to at least the first offset.

By means of step 201 to step 204 above, upon receipt of an adaptive-adjustment instruction, a ratio of air to fuel of an engine is reduced by a first preset step until a rotational speed after the reduction is less than the rotational speed before the reduction with a difference therebetween greater than a preset drop value. The ratio of air to fuel of the engine is increased by a second preset step until the rotational speed after the increase is less than the rotational speed before the increase with a difference therebetween greater than the preset drop value. A first offset of a control parameter corresponding to an adaptive-adjustment state for the engine is determined by a reduced ratio of air to fuel and an increased ratio of air to fuel, wherein the control parameter includes at least one of an ignition angle parameter and a fuel injection parameter. The operation of the engine is controlled at a current time according to at least the first offset. The problems of unstable operation, poor combustion and insufficient power of the engine under the complex conditions have been solved, and the engine can complete the adaptive-adjustment by controlling the operation of the engine with the offset corresponding to the adaptive-adjustment state, thereby saving operation time, avoiding a time lag caused by cumbersome operation sequences or steps, and improving user experience.

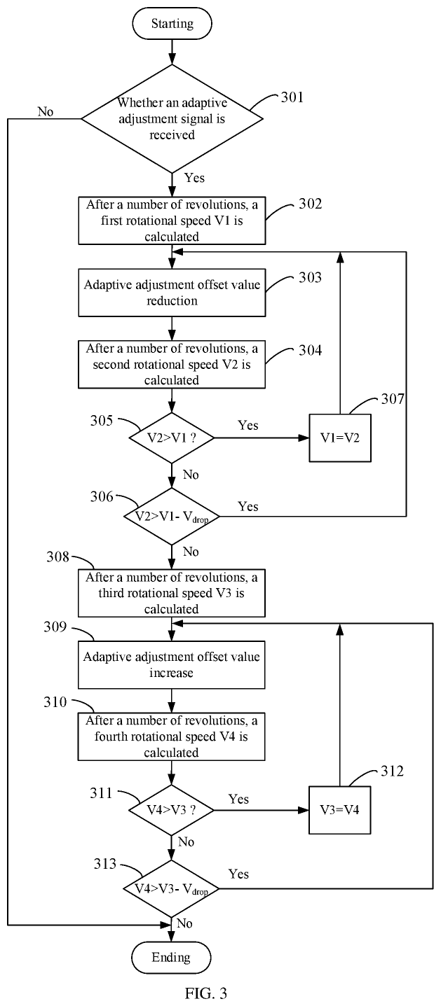

FIG. 3 is a flowchart diagram of operation control of an engine in an adaptive-adjustment state according to an embodiment of the present disclosure, and as shown in FIG. 3, the flowchart may include the following steps:

At step 301, it is judged that whether an adaptive-adjustment signal is received, and if yes, step 302 is performed.

At step 302, after a number of revolutions, a first rotational speed V1 is calculated, and then step 303 is performed.

At step 303, an opening degree of a solenoid valve is controlled, a ratio of air to fuel is reduced, and then step 304 is performed.

At step 304, after a number of revolutions, a second rotational speed V2 is calculated, and then step 305 is performed.

At step 305, comparing the second rotational speed and the first rotational speed, if the second rotational speed is greater than the first rotational speed, step 307 is performed; otherwise, step 306 is performed.

At step 306, it is judged that whether the second rotational is greater than a difference between the first rotational speed and a drop value V_{drop}, if yes, step 303 is performed; otherwise, step 308 is performed.

At step 307, the second rotational speed is taken as the first rotational speed, and then step 303 is performed.

At step 308, after a number of revolutions, a third rotational speed V3 is calculated, and then step 309 is performed.

At step 309, the opening degree of the solenoid valve is controlled and the ratio of air to fuel is increased, and then step 310 is performed.

At step 310, after a number of revolutions, a fourth rotational speed V4 is calculated, and then step 311 is performed.

At step 311, comparing the fourth rotational speed V4 and the third rotational speed V3, if the fourth rotational speed V4 is greater than the third rotational speed V3, step 312 is performed; otherwise, step 313 is performed.

At step 312, the fourth rotational speed V4 is taken as the third rotational speed V3, and then step 309 is performed.

At step 313, it is judged that whether the fourth rotational is greater than a difference between the third rotational speed and the drop value V_{drop}, if yes, step 309 is performed; otherwise, the adaptive-adjustment is completed.

By means of step 301 to step 312 described above, the optimal fuel consumption point of the engine can be found.

In this embodiment, a fuel amount is adjusted in one direction until the rotational speed drops down during the adaptive-adjustment, for example, 50 revolutions per minute, and when the drop exceeds 50 revolutions per minute, the fuel amount is adjusted in an opposite direction, and a directly opposite direction adjustment also realizes that the drop exceeds 50 revolutions per minute, and the adjustment ends at this time.

In some embodiments, the preset drop value ranges from 0-200 revolutions per minute.

In some embodiments, the adaptive-adjustment method for engine operation further includes the following steps:

A reference value and a second offset of the control parameter of the engine are obtained. The second offset includes at least one of an offset of the control parameter of the engine in a start-up state and an offset of the control parameter of the engine in a cold engine state.

In the present embodiment, after the reference value and the second offset of the control parameter of the engine are obtained, the following steps are performed: the reference value, the first offset and the second offset are combined into a final value of the control parameter, and the operation of the engine at the current time is controlled according to the final value of the control parameter.

In the present embodiment, during the control of the engine operation, the control parameters of the engine operating according to conventional control parameters are also detected. Specifically, the control parameters include a reference value of the control parameter determined by the rotational speed and temperature of the engine at the current time. After the rotational speed and temperature of the engine at the current time are detected, the base table of speed-temperature-ignition angle and the base table of speed-temperature-fuel injection are used to look up ignition angle reference value and fuel injection reference value of engine operation. The base table of speed-temperature-ignition angle and the base table of speed-temperature-fuel injection include ignition angles and fuel injections experimentally measured through preset parameters. In practical measurement, the ignition angles and the fuel injections may be determined by the preset parameters (rotational speed and temperature) of heuristics and the operation condition and the emission condition during the engine operation.

The operation condition and the emission condition during the engine operation are checked as follows: checking whether a fuel consumption, an emission data of an emitter, a torque output and a rotational speed fluctuation meet an engine criteria. In compliance with the criteria, the reference value of the control parameter corresponding to the preset parameter is determined. Then the reference value of the control parameter is written into the base table of speed-temperature-ignition angle and the base table of speed-temperature-fuel injection at a position corresponding to the preset parameter.

In the present embodiment, working states of the engine at the current time includes one or more working states. Specifically, a start-up state and a cold engine state are included, and the second offset of the control parameter of the engine obtained as an offset of the control parameter is determined by the working state of the engine at the current time. After the offset of the control parameter is determined by the working state of the engine at the current time, a total control parameter for controlling the operation of the engine can be determined by the reference value of the control parameter, the offset of the working state at the current time, and the offset of the adaptive-adjustment state. In the present embodiment, each working state of the engine at the current time is non-independent, and the offset of each working state is different.

In the present embodiment, the reference value of the control parameter and the superimposed first offset and second offset are combined to obtain a total control parameter value, and then an ignition time (ignition angle) and a ratio of air to fuel (fuel injection) of a final combustible mixed gas are determined.

A reference value and a second offset of the control parameter of the engine are obtained. The reference value, the first offset and the second offset are combined into a final value of the control parameter, and the operation of the engine at the current time is controlled by the final value of the control parameter, thereby saving operation time, avoiding a time lag caused by cumbersome operation sequences or steps, and improving user experience.

In some embodiments, a reference value and a second offset of the control parameter of the engine are obtained as the following steps:

The rotational speed and temperature of the engine at the current time are obtained.

A first table of preset control parameter is obtained, wherein the first table of preset control parameter includes correspondence information among the rotational speed of the engine, the temperature of the engine, and the reference value of the control parameter of the engine.

A reference value of the control parameter under the rotational speed and the temperature at the current time is looked up in the first table.

In the present embodiment, the first table of preset control parameter is experimentally measured in advance, i.e. the described base table of speed-temperature-ignition angle.

The rotational speed and temperature of the engine at the current time are obtained, and a first table of preset control parameter is obtained to look up a reference value of the control parameter under the rotational speed and temperature at the current time, thereby implementing looking up a reference value of the control parameter for the engine operation by the first table of preset control parameter, i.e. looking up and obtaining an ignition angle reference value and a fuel injection reference value.

In some embodiments, the second offset of the control parameters of the engine is obtained as the following steps:

A rotational speed and a temperature of the engine are obtained at the current time.

It is detected that whether the engine is in a start-up state at the current time.

When the engine is in a start-up state at the current time, an offset of the control parameter corresponding to the start-up state under the rotational speed and the temperature is looked up in a second table of preset control parameter, and the offset of the control parameter corresponding to the start-up state is taken as the second offset, wherein the second table of preset control parameter includes correspondence information among the rotational speed of the engine, the temperature of the engine, and the offset of the control parameter of the engine in the start-up state.

In the present embodiment, the second table of preset control parameter is also a reference table generated through preset experimental measurement, and the second table of preset control parameter is associated with a mapping relationship among the rotational speed, the cylinder temperature of the engine, and engine offset.

The rotational speed and temperature of the engine at the current time is obtained. It is detected whether the engine is in the start-up state at the current time, and when it is detected that the engine is in the start-up state at the current time, an offset of the control parameter corresponding to the start-up state under the rotational speed and the temperature is looked up in the second table of preset control parameter, and the offset of the control parameter corresponding to the start-up state is taken as the second offset, thereby implementing determining the second offset of the engine in the start-up state at the current time through the second table of preset control parameter.

In some embodiments, it is detected whether the engine is in a start-up state at the current time as the following steps:

A first number of revolutions from the start of the engine to the current time is detected.

It is judged that whether the first number of revolutions is less than a first preset number of revolutions, wherein the first preset number of revolutions represents the number of revolutions required for the engine from the start of the engine to the exit from the start-up state.

When the first number of revolutions is less than the first preset number of revolutions, it is determined that the engine is in a start-up state at the current time.

In the present embodiment, a first number of revolutions from the start of the engine to the current time is detected, and it is judged whether the first number of revolutions is less than a first preset number of revolutions, when the first number of revolutions is less than the first preset number of revolutions, the engine is in a start-up state at the current time, thereby implementing detecting confirmation that the engine is in a start-up state at the current time.

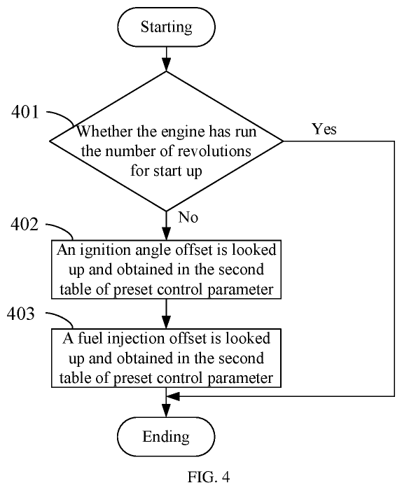

FIG. 4 is a flowchart diagram of operation control of an engine in a start-up state according to an embodiment of the present disclosure. As shown in FIG. 4, the flowchart may include the following steps:

At step 401, it is judged that whether the engine has run the number of revolutions for start up, and if not, step 402 is performed.

At step 402, an ignition angle offset is looked up and obtained in the second table of preset control parameter, and then step 403 is performed.

At step 403, a fuel injection offset is looked up and obtained in the second table of preset control parameter.

By means of step 401 to step 403 described above, implementing detection of the second offset of the engine in the start-up state.

In some embodiments, the second offset of the control parameters of the engine is obtained as the following steps:

A rotational speed and a temperature of the engine are obtained at the current time.

It is detected that whether the engine is in a cold engine state at the current time.

When the engine is in a cold engine state at the current time, an offset of the control parameter corresponding to the cold engine state under the rotational speed and the temperature is looked up in a third table of preset control parameter, and the offset of the control parameter corresponding to the cold engine state is taken as the second offset, wherein the third table of preset control parameter includes correspondence information among the rotational speed of the engine, the temperature of the engine, and the offset of the control parameter of the engine in the cold engine state.

In the present embodiment, the third table of preset control parameter is also a reference table generated through preset experimental measurement, and the third table of preset control parameter is associated with a mapping relationship among engine rotational speed, engine cylinder temperature, and engine offset.

The rotational speed and temperature of the engine at the current time is obtained. It is detected whether the engine is in the cold engine state at the current time, and when it is detected that the engine is in the cold engine state at the current time, an offset of the control parameter corresponding to the cold engine state under the rotational speed and the temperature is looked up in the third table of preset control parameter, and the offset of the control parameter corresponding to the cold engine state is taken as the second offset, thereby implementing determining the second offset of the engine in the cold engine state at the current time through the third table of preset control parameter.

In some embodiments, it is detected whether the engine is in a cold engine state at the current time as the following steps:

A second preset number of revolutions corresponding to the temperature is detected, wherein the second preset number of revolutions represents the number of revolutions required for the engine at the temperature from the start of engine to the exit from the cold engine state.

A first number of revolutions from the start of the engine to the current time is detected. The number of revolutions at the current time is calculated by the temperature at the current time.

When the first number of revolutions is less than the second preset number of revolutions, it is determined that the engine is in a cold engine state at the current time.

In the present embodiment, after the engine begins to operate, the temperature inside the engine cylinder is indirectly reflected by measured temperature inside an igniter, i.e. the temperature inside the cylinder is measured by measuring a temperature of a silicon steel wafer connected to the engine cylinder on the igniter, and the number of revolutions required from the start of the engine at a certain temperature to the exit from the cold engine state is obtained by looking up the table with the temperature inside the cylinder. The second preset number of revolutions is a number of revolutions corresponding to a certain cold engine temperature obtained by measuring the temperature at which the engine starts, measuring the temperature at the time of the exit from the cold engine state, and counting the number of revolutions from the start of engine to the exit from a preset cold machine state.

A second preset number of revolutions corresponding to the temperature is detected, and a first number of revolutions from the start of the engine to the current time is detected. When the first number of revolutions is less than the second preset number of revolutions, it is determined that the engine is in a cold engine state at the current time, thereby implementing detecting confirmation that the engine is in a cold engine state at the current time.

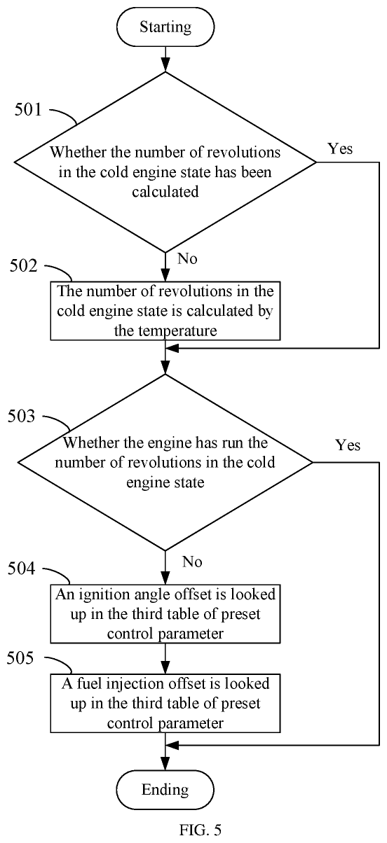

FIG. 5 is a flowchart diagram of operation control of an engine in a cold engine state according to an embodiment of the present disclosure. As shown in FIG. 5, the flowchart may include the following steps:

At step 501, it is judged that whether the number of revolutions in the cold engine state has been calculated, if yes, step 503 is performed; otherwise, step 502 is performed.

At step 502, the number of revolutions in the cold engine state is calculated by the temperature (cylinder temperature), and then step 503 is performed.

At step S503, it is judged that whether the engine has run the number of revolutions in the cold engine state, and if yes, ending; otherwise, step 504 is performed.

In the present embodiment, the judged number of revolutions in the cold engine state includes actual number of revolutions calculated by the temperature. A judged threshold value is experimentally measured, i.e. the second preset number of revolutions described above.

At step 504, an ignition angle offset is looked up in the third table of preset control parameter, and then step 505 is performed.

At step 505, a fuel injection offset is looked up in the third table of preset control parameter.

By means of step 501 to step 505 described above, implementing detection of the second offset of the engine in the cold engine state.

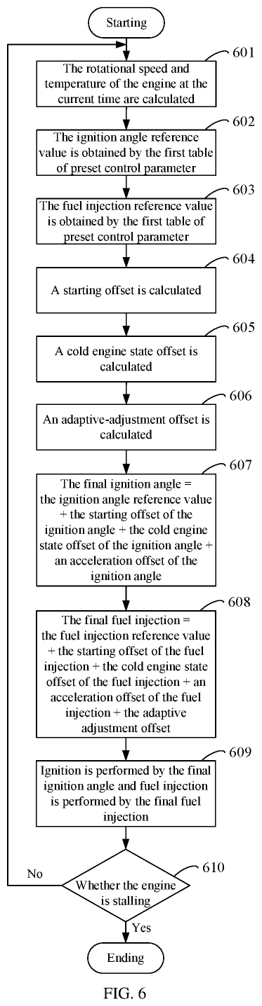

FIG. 6 is a flowchart diagram of an adaptive-adjustment method for engine operation according to an embodiment of the present disclosure. As shown in FIG. 6, the flowchart may include the following steps:

At step 601, the rotational speed and temperature of the engine at the current time are calculated.

At step 602, the ignition angle reference value is obtained by the first table of preset control parameter, wherein the ignition angle reference value in the first table of preset control parameter is experimentally measured.

At step 603, the fuel injection reference value is obtained by the first table of preset control parameter.

At step 604, a starting offset is calculated.

At step 605, a cold engine state offset is calculated.

At step 606, an adaptive-adjustment offset is calculated.

At step 607, the final ignition angle is determined by the ignition angle reference value, the starting offset of the ignition angle, the cold engine state offset of the ignition angle and an acceleration offset of the ignition angle.

At step 608, the final fuel injection is determined by the fuel injection reference value, the starting offset of the fuel injection, the cold engine state offset of the fuel injection, an acceleration offset of the fuel injection and the adaptive-adjustment offset.

At step 609, ignition is performed by the final ignition angle and fuel injection is performed by the final fuel injection.

At step 610, it is judged whether the engine is stalling, if yes, stopping, otherwise, step 601 is performed.

It should be noted that, the steps shown in the foregoing flowchart or the flowchart of the drawings may be performed in a computer system which includes a set of computer executable instructions. Although a logical order is shown in the flowchart diagram, in some cases, the steps shown or described may be performed in an order different from that here.

The present embodiment further provides an adaptive-adjustment device for engine operation, and the device is configured to implement the described embodiments and optional implementations, and the description thereof is omitted. As used below, the terms “module”, “unit”, “sub-unit”, etc. may implement at least one of a combination of software and hardware of a predetermined function. Although the device described in the following embodiments is preferably implemented in software, implementation of hardware, or a combination of software and hardware is also possible and contemplated.

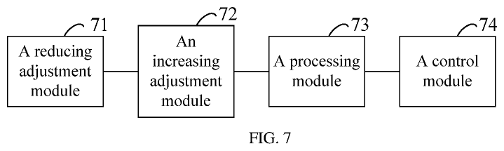

FIG. 7 is a block diagram of a structure of an adaptive-adjustment device for engine operation according to an embodiment of the present disclosure, and as shown in FIG. 7, the device includes:

A reducing adjustment module 71, configured to reduce a ratio of air to fuel of an engine by a first preset step upon receipt of an adaptive-adjustment instruction, until a rotational speed after the reduction is less than the rotational speed before the reduction, and a rotational speed difference between the rotational speed before the reduction and the rotational speed after the reduction is greater than a preset drop value.

An increasing adjustment module 72, configured to increase the ratio of air to fuel of the engine by a second preset step until the rotational speed after the increase is less than the rotational speed before the increase, and a rotational speed difference between the rotational speed before the increase and the rotational speed after the increase is greater than the preset drop value.

A processing module 73, configured to determine a first offset of a control parameter corresponding to an adaptive-adjustment state for the engine according to a reduced ratio of air to fuel and an increased ratio of air to fuel.

A control module 74, configured to control operation of the engine at a current time according to at least the first offset.

In some embodiments, the device further includes:

A detecting module is configured to obtain a reference value and a second offset of the control parameter of the engine; wherein the second offset includes at least one of an offset of the control parameter of the engine in a start-up state and an offset of the control parameter of the engine in a cold engine state.

The control module 74 is further configured to combine the reference value, the first offset and the second offset into a final value of the control parameter, and control the operation of the engine at the current time according to the final value of the control parameter.

In some embodiments, the detecting module is configured to obtain a rotational speed and a temperature of the engine at the current time, and obtain a first table of preset control parameter, including corresponding relationship information among the rotational speed of the engine, the temperature of the engine, and the reference value of the control parameter of the engine, and look up a reference value of the control parameter under the rotational speed and temperature at the current time in the first table.

In some embodiments, the detecting module is configured to obtain a rotational speed and a temperature of the engine at the current time, and detect whether the engine is in a start-up state at the current time, when it is detected that the engine is in a start-up state at the current time, look up an offset of the control parameter corresponding to the start-up state under the rotational speed and the temperature in a second table of preset control parameter, and take the offset of the control parameter corresponding to the start-up state as the second offset, wherein the second table includes correspondence information among the rotational speed of the engine, the temperature of the engine, and the offset of the control parameter of the engine in the start-up state.

In some embodiments, the detecting module is configured to detect a first number of revolutions from the start of the engine to the current time, and judge whether the first number of revolutions is less than a first preset number of revolutions, wherein the first preset number of revolutions represents the number of revolutions required for the engine from the start of the engine to the exit from the start-up state, when the first number of revolutions is less than the first preset number of revolutions, determine that the engine is in a start-up state at the current time.

In some embodiments, the detecting module is configured to obtain a rotational speed and a temperature of the engine at the current time, and detect whether the engine is in a cold engine state at the current time, when it is detected that the engine is in a cold engine state at the current time, look up an offset of the control parameter corresponding to the cold engine state under the rotational speed and the temperature in a third table of preset control parameter, and take the offset of the control parameter corresponding to the cold engine state as the second offset, wherein the third table of preset control parameter includes corresponding information among the rotational speed of the engine, the temperature of the engine, and the offset of the control parameter of the engine in the cold engine state.

In some embodiments, the detecting module is configured to determine a second preset number of revolutions corresponding to the temperature, wherein the second preset number of revolutions represents the number of revolutions required for the engine at the temperature from the start of the engine to the exit from the cold engine state, and detect a first number of revolutions from the start of the engine to the current time, when the first number of revolutions is less than the second preset number of revolutions, determine that the engine is in a cold engine state at the current time.

The present embodiment further provides an electronic device, including a memory and a processor, wherein the memory stores a computer program, and the processor is configured to execute the computer program to implement the steps in any of the foregoing method embodiments.

Optionally, the above electronic device may further include a transmission device and an input and output device, wherein the transmission device is connected to the above processor and the input and output device is connected to the above processor.

Optionally, in the present embodiment, the above processor may be set to execute the following steps by means of a computer program:

At step 1, upon receipt of an adaptive-adjustment instruction, a ratio of air to fuel of an engine is reduced by a first preset step until a rotational speed after the reduction is less than the rotation speed before the reduction, and a rotational speed difference between the rotational speed before the reduction and the rotational speed after the reduction is greater than a preset drop value.

At step 2, the ratio of air to fuel of the engine is increased by a second preset step until the rotational speed after the increase is less than the rotational speed before the increase, and a rotational speed difference between the rotational speed before the increase and the rotational speed after the increase is greater than the preset drop value.

At step 3, a first offset of a control parameter corresponding to an adaptive-adjustment state for the engine is determined by a reduced ratio of air to fuel and an increased ratio of air to fuel, wherein the control parameter includes at least one of an ignition angle parameter and a fuel injection parameter.

At step 4, the operation of the engine is controlled at a current time according to at least the first offset.

It should be noted that, specific examples in the present embodiment may refer to the examples described in the above embodiments and optional implementations, and the present embodiment will not be repeated herein.

Further, in conjunction with the adaptive-adjustment method for engine operation in the above embodiments, the present embodiments may provide a storage medium to implement the method. The storage medium has a computer program stored thereon, and the computer program implements any of the adaptive-adjustment methods for engine operation of the above embodiments when executed by a processor.

The technical features of the above-described embodiments may be combined in any combination. For the sake of brevity of description, all possible combinations of the technical features in the above embodiments are not described. However, as long as there is no contradiction between the combinations of these technical features, all should be considered as within the scope of this disclosure.

The above-described embodiments are merely illustrative of several embodiments of the present disclosure, and the description thereof is relatively specific and detailed, but is not to be construed as limiting the scope of the disclosure. It should be noted that a number of variations and modifications may be made by those skilled in the art without departing from the spirit and scope of the disclosure. Therefore, the scope of the disclosure should be determined by the appended claims.

1. An adaptive-adjustment method for engine operation, wherein the method comprises:
upon receipt of an adaptive-adjustment instruction, reducing a ratio of air to fuel of an engine by a first preset step until a rotational speed after the reduction is less than the rotational speed before the reduction, and a rotational speed difference between the rotational speed before the reduction and the rotational speed after the reduction is greater than a preset drop value;
increasing the ratio of air to fuel of the engine by a second preset step until the rotational speed after the increase is less than the rotational speed before the increase, and a rotational speed difference between the rotational speed before the increase and the rotational speed after the increase is greater than the preset drop value;
determining a first offset of a control parameter corresponding to an adaptive-adjustment state for the engine according to a reduced ratio of air to fuel and an increased ratio of air to fuel, wherein the control parameter comprises at least one of an ignition angle parameter and a fuel injection parameter; and
controlling the engine at a current time according to at least the first offset.

2. The method of claim 1, further comprising:
obtaining a reference value and a second offset of the control parameter of the engine;
wherein the second offset comprises at least one of an offset of the control parameter of the engine in a start-up state and an offset of the control parameter of the engine in a cold engine state;
wherein the controlling the operation of the engine at the current time according to at least the first offset comprises: combining the reference value, the first offset and the second offset into a final value of the control parameter, and controlling the operation of the engine at the current time according to the final value of the control parameter.

3. The method of claim 2, wherein the obtaining the reference value of the control parameter of the engine comprises:
obtaining a rotational speed and a temperature of the engine at the current time;
obtaining a first table of preset control parameters, wherein the first table comprises correspondence information among the rotational speed of the engine, the temperature of the engine, and the reference value of the control parameter of the engine; and
looking up a reference value of the control parameter under the rotational speed and the temperature at the current time in the first table.

4. The method of claim 2, wherein the obtaining the second offset of the control parameter of the engine comprises:
obtaining a rotational speed and a temperature of the engine at the current time;
detecting whether the engine is in a start-up state at the current time; and
when it is detected that the engine is in a start-up state at the current time, looking up an offset of the control parameter corresponding to the start-up state under the rotational speed and the temperature in a second table of preset control parameters, and taking the offset of the control parameter corresponding to the start-up state as the second offset, wherein the second table comprises correspondence information among the rotational speed of the engine, the temperature of the engine, and the offset of the control parameter of the engine in the start-up state.

5. The method of claim 4, wherein the detecting whether the engine is in a start-up state at the current time comprises:
detecting a first number of revolutions from a start of the engine to the current time;
judging whether the first number of revolutions is less than a first preset number of revolutions, wherein the first preset number of revolutions represents the number of revolutions required for the engine from the start of the engine to an exit from the start-up state; and
when the first number of revolutions is less than the first preset number of revolutions, determining that the engine is in the start-up state at the current time.

6. The method of claim 2, wherein the obtaining the second offset of the control parameter of the engine comprises:
obtaining a rotational speed and a temperature of the engine at the current time;
detecting whether the engine is in a cold engine state at the current time; and
when it is detected that the engine is in a cold engine state at the current time, looking up an offset of the control parameter corresponding to the cold engine state under the rotational speed and the temperature in a third table of preset control parameter, and taking the offset of the control parameter corresponding to the cold engine state as the second offset, wherein the third table of preset control parameters comprises corresponding information among the rotational speed of the engine, the temperature of the engine, and the offset of the control parameter of the engine in the cold engine state.

7. The method of claim 6, wherein the detecting whether the engine is in a cold engine state at the current time comprises:
determining a second preset number of revolutions corresponding to the temperature, wherein the second preset number of revolutions represents the number of revolutions required for the engine at the temperature from the start of the engine to the exit from the cold engine state;
detecting a first number of revolutions from the start of the engine to the current time; and
when the first number of revolutions is less than the second preset number of revolutions, determining that the engine is in the cold engine state at the current time.

8. The adaptive adjusting method for engine operation of claim 1, wherein the preset drop value ranges from 0-200 revolutions per minute.

9. An adaptive-adjustment device for engine operation, comprising:
means for reducing a ratio of air to fuel of an engine by a first preset step upon receipt of an adaptive-adjustment instruction, until a rotational speed after the reduction is less than the rotational speed before the reduction, and a rotational speed difference between the rotational speed before the reduction and the rotational speed after the reduction is greater than a preset drop value;
means for increasing the ratio of air to fuel of the engine by a second preset step until the rotational speed after the increase is less than the rotational speed before the increase, and a rotational speed difference between the rotational speed before the increase and the rotational speed after the increase is greater than the preset drop value;
means for determining a first offset of a control parameter corresponding to an adaptive-adjustment state for the engine according to a reduced ratio of air to fuel and an increased ratio of air to fuel; and
means for controlling operation of the engine at a current time according to at least the first offset.

10. An electronic device, comprising a memory and a processor, wherein the memory stores a computer program, and the processor is configured to execute the computer program to implement an adaptive-adjustment method for engine operation comprising:
upon receipt of an adaptive-adjustment instruction, reducing a ratio of air to fuel of an engine by a first preset step until a rotational speed after the reduction is less than the rotational speed before the reduction, and a rotational speed difference between the rotational speed before the reduction and the rotational speed after the reduction is greater than a preset drop value;
increasing the ratio of air to fuel of the engine by a second preset step until the rotational speed after the increase is less than the rotational speed before the increase, and a rotational speed difference between the rotational speed before the increase and the rotational speed after the increase is greater than the preset drop value;
determining a first offset of a control parameter corresponding to an adaptive-adjustment state for the engine according to a reduced ratio of air to fuel and an increased ratio of air to fuel, wherein the control parameter comprises at least one of an ignition angle parameter and a fuel injection parameter; and
controlling the engine at a current time according to at least the first offset.

11. (canceled)

12. The electronic device of claim 10, wherein the adaptive-adjustment method for engine operation further comprises:
obtaining a reference value and a second offset of the control parameter of the engine;
wherein the second offset comprises at least one of an offset of the control parameter of the engine in a start-up state and an offset of the control parameter of the engine in a cold engine state;
wherein the controlling the operation of the engine at the current time according to at least the first offset comprises: combining the reference value, the first offset and the second offset into a final value of the control parameter, and controlling the operation of the engine at the current time according to the final value of the control parameter.

13. The electronic device of claim 12, wherein the adaptive-adjustment method for engine operation further comprises:
obtaining a rotational speed and a temperature of the engine at the current time;
obtaining a first table of preset control parameters, wherein the first table comprises correspondence information among the rotational speed of the engine, the temperature of the engine, and the reference value of the control parameter of the engine; and
looking up a reference value of the control parameter under the rotational speed and the temperature at the current time in the first table.

14. The electronic device of claim 12, wherein the adaptive-adjustment method for engine operation further comprises:
obtaining a rotational speed and a temperature of the engine at the current time;
detecting whether the engine is in a start-up state at the current time; and
when it is detected that the engine is in a start-up state at the current time, looking up an offset of the control parameter corresponding to the start-up state under the rotational speed and the temperature in a second table of preset control parameters, and taking the offset of the control parameter corresponding to the start-up state as the second offset, wherein the second table comprises correspondence information among the rotational speed of the engine, the temperature of the engine, and the offset of the control parameter of the engine in the start-up state.

15. The electronic device of claim 14, wherein the adaptive-adjustment method for engine operation further comprises:
detecting a first number of revolutions from the start of the engine to the current time;
judging whether the first number of revolutions is less than a first preset number of revolutions, wherein the first preset number of revolutions represents the number of revolutions required for the engine from the start of the engine to the exit from the start-up state; and
when the first number of revolutions is less than the first preset number of revolutions, determining that the engine is in the start-up state at the current time.

16. The electronic device of claim 12, wherein the adaptive-adjustment method for engine operation further comprises:
obtaining a rotational speed and a temperature of the engine at the current time;
detecting whether the engine is in a cold engine state at the current time; and
when it is detected that the engine is in a cold engine state at the current time, looking up an offset of the control parameter corresponding to the cold engine state under the rotational speed and the temperature in a third table of preset control parameter, and taking the offset of the control parameter corresponding to the cold engine state as the second offset, wherein the third table of preset control parameters comprises corresponding information among the rotational speed of the engine, the temperature of the engine, and the offset of the control parameter of the engine in the cold engine state.

17. The electronic device of claim 16, wherein the adaptive-adjustment method for engine operation further comprises:
determining a second preset number of revolutions corresponding to the temperature, wherein the second preset number of revolutions represents the number of revolutions required for the engine at the temperature from the start of the engine to the exit from the cold engine state;
detecting a first number of revolutions from the start of the engine to the current time; and
when the first number of revolutions is less than the second preset number of revolutions, determining that the engine is in the cold engine state at the current time.

18. The electronic device of claim 10, wherein the preset drop value ranges from 0-200 revolutions per minute.

19. The storage medium of claim 11, wherein the adaptive-adjustment method for engine operation further comprises:
obtaining a reference value and a second offset of the control parameter of the engine;
wherein the second offset comprises at least one of an offset of the control parameter of the engine in a start-up state and an offset of the control parameter of the engine in a cold engine state;
wherein the controlling the operation of the engine at the current time according to at least the first offset comprises: combining the reference value, the first offset and the second offset into a final value of the control parameter, and controlling the operation of the engine at the current time according to the final value of the control parameter.

20. The storage medium of claim 19, wherein the adaptive-adjustment method for engine operation further comprises:
obtaining a rotational speed and a temperature of the engine at the current time;
obtaining a first table of preset control parameters, wherein the first table comprises correspondence information among the rotational speed of the engine, the temperature of the engine, and the reference value of the control parameter of the engine; and
looking up a reference value of the control parameter under the rotational speed and the temperature at the current time in the first table.
